(19) United States
(12) Patent Application Publication
(10) Pub. No.: US 2024/0259400 A1
(43) Pub. Date: Aug. 1, 2024

(54) SYSTEM AND METHOD FOR GLOBALLY DISTRIBUTED FIREWALL PROTECTION

(71) Applicants: Naveen Kumar SHARMA, Jaipur (IN); Apurv BORDIA, Jaipur (IN)

(72) Inventors: Naveen Kumar SHARMA, Jaipur (IN); Apurv BORDIA, Jaipur (IN); Kiran SHARMA, Jaipur (IN); Nupur BORDIA, Jaipur (IN); Shankar Ganesh Pillaiyar Nattamai Jeyaprakash, Bangalore (IN)

(21) Appl. No.: 18/423,367

(22) Filed: Jan. 26, 2024

(30) Foreign Application Priority Data
Jan. 26, 2023 (IN) 202211042861

(51) Int. Cl. H04L 9/40

(52) U.S. Cl. CPC H04L 63/1416; H04L 63/0218

(57) ABSTRACT

Disclosed is a system including a plurality of nodes (102) that includes a first through third sets of nodes (102a-102c). The second set of nodes (102b) detects a type of attack on each node of the first set of nodes (102a), generates a set of attack patterns for the first set of nodes (102b), select one or more attack patterns having a matching score value higher than a pre-defined threshold value, generates a first set of protocols and a second set of protocols. The third set of nodes (102c) checks validity of each protocol of the first set of protocols and the second set of protocols, to generate a set of valid protocols, and distributes the set of valid protocols to each node of the plurality of nodes (102).

### RELATED FIELD

The present disclosure relates to a field of security in cloud computing. More particularly, the present disclosure relates to a system and a method for globally distributed firewall protection.

### BACKGROUND

Firewall is a network security device that monitors and filters incoming and outgoing network traffic based on pre-defined protocols. The main purpose of a firewall is to allow non-threatening traffic in and to keep dangerous traffic out. Not only does a firewall block unwanted traffic, but can also help to block malicious agents to affect any important data.

The present firewall systems work on centrally stored data. Such systems lack an adaptability towards identification and mitigation of new attacks and thus fail to perform in real time when attacked by a new kind of attack.

Thus, an adaptive firewall system and method for identification, prevention and mitigation of attacks in real time is an ongoing effort and demands a need for improvised technical solution that overcomes the aforementioned problems.

### SUMMARY

In an aspect of the present disclosure, a system includes a plurality of nodes. The plurality of nodes include a first set of nodes, a second set of nodes, and a third set of nodes. The second set of nodes are configured to detect a type of attack on each node of the first set of nodes. The second set of nodes are further configured to generate a set of attack patterns for the first set of nodes. Furthermore, the second set of nodes are configured to select one or more attack patterns from the generated set of attack patterns having a matching score value higher than a pre-defined threshold value. Furthermore, the second set of nodes are configured to generate a first set of protocols for the one or more attack patterns having the matching score value higher than the pre-defined threshold value. Furthermore, the second set of nodes are configured to generate a second set of protocols for the one or more attack patterns having the matching score value lower than the pre-defined threshold value. The third set of nodes are configured to check a validity of each protocol of the first set of protocols and a validity of each protocol of the second set of protocols, to generate a set of valid protocols. The third set of nodes are further configured to distribute the set of valid protocols to each node of the plurality of nodes.

In some aspects, the plurality of nodes are configured to segregate the plurality of nodes into the first through third set of nodes. The first set of nodes are segregated based on traffic data and a category of service of each node of the plurality of nodes using one or more artificial intelligence techniques. The second and third sets of nodes are segregated based on the traffic data, the category of service, a computation capability, and a storage capability, of each node of the plurality of nodes, using one or more artificial intelligence techniques.

In some aspects, prior to the segregation of the plurality of nodes, the plurality of nodes are configured to share, for each node of the plurality of nodes, traffic data, a category of service, a computation capability, and a storage capability with the plurality of nodes.

In some aspects, prior to the detection of the type of attack on the on each node of the first set of nodes, the plurality of nodes are configured to detect a cyber-attack on each node of the first set of nodes. To detect the cyber-attack on each node of the first set of nodes, the plurality of nodes are configured to compare the traffic data of each node of the plurality of nodes with pre-defined traffic data corresponding to the category of service of each node of the plurality of nodes.

In some aspects, prior to the selection of the one or more attack patterns from the generated set of attack patterns, the second set of nodes are configured to compare the generated each attack pattern of the set of attack patterns with the pre-defined set of attack patterns. The second set of nodes are further configured to generate the matching score value for each attack pattern for the set of attack patterns.

In some aspects, upon the distribution of the one or more valid protocols, the second set of nodes are configured to mitigate the cyber-attack on one or more node of the first set of nodes using the set of valid protocols.

In another aspect of the present disclosure, a method includes detecting, by way of a second set of nodes of a plurality of nodes, a type of attack on each node of a first set of nodes of the plurality of nodes. The method further includes generating, by way of the second set of nodes, a set of attack patterns for the first set of nodes. Furthermore, the method includes selecting, by way of the second set of nodes, one or more attack patterns from the generated set of attack patterns having a matching score value higher than a pre-defined threshold value. Furthermore, the method includes generating, by way of the second set of nodes, a first set of protocols for the one or more attack patterns having the matching score value higher than the pre-defined threshold value. Furthermore, the method includes generating, by way of the second set of nodes, the second set of protocols for the one or more attack patterns having the matching score value lower than the pre-defined threshold value. Furthermore, the method includes checking, by way of a third set of nodes of the plurality of nodes, a validity of each protocol of the first set of protocols and a validity of each protocol of the second set of protocols, to generate a set of valid protocols. Furthermore, the method includes distributing, by way of the third set of nodes, the set of valid protocols to each node of the plurality of nodes.

In some aspects, the method further incudes segregating, by way of the plurality of nodes, the plurality of nodes into the first through third set of nodes. The first set of nodes are segregated based on traffic data and a category of service of each node of the plurality of nodes using one or more artificial intelligence techniques. The second and third sets of nodes are segregated based on the traffic data, the category of service, a computation capability, and a storage capability, of each node of the plurality of nodes, using one or more artificial intelligence techniques.

### BRIEF DESCRIPTION OF THE DRAWINGS

Other objects, features, and advantages of the aspect will be apparent from the following description when read with reference to the accompanying drawings. In the drawings, wherein like reference numerals denote corresponding parts throughout the several views:

The diagrams are for illustration only, which thus is not a limitation of the present disclosure, and wherein:

FIG. 1 illustrates a block diagram of a system for globally distributed firewall protection, in accordance with an exemplary aspect of the present disclosure;

FIG. 2 illustrates a block diagram of a first node of a first set of nodes of the system for globally distributed firewall protection of FIG. 1, in accordance with an exemplary aspect of the present disclosure:

FIG. 3 illustrates a block diagram of a first node of a second set of nodes of the system for globally distributed firewall protection of FIG. 1, in accordance with an exemplary aspect of the present disclosure:

FIG. 4 illustrates a block diagram of a first node of a third set of nodes of the system for globally distributed firewall protection of FIG. 1, in accordance with an exemplary aspect of the present disclosure; and

FIG. 5 illustrates a flow chart of a method for globally distributed firewall protection, in accordance with an exemplary aspect of the present disclosure.

To facilitate understanding, like reference numerals have been used, where possible to designate like elements common to the figures.

### DETAILED DESCRIPTION OF THE PREFERRED ASPECTS

Various aspect of the present disclosure provides a system and a method for globally distributed firewall protection. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the claimed subject matter might also be embodied in other ways, to include different features or combinations of features similar to the ones described in this document, in conjunction with other technologies. Generally, the various aspects including the example aspects relate to the system, and the method depicting the globally distributed firewall protection.

As mentioned, there remains a need for identification, prevention and mitigation of attacks in real time. The present aspect, therefore: provides a system and a method for globally distributed firewall protection. In some aspects, the system is configured to detect, prevent and/or mitigate security threats and/or cyber-attacks on each node of the distributed blockchain network. The system monitors one or more attack patterns and/or malicious data on each node of the distributed blockchain network and determine a way to mitigate the cyber-attacks in real time. The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practiced and to further enable those of skill in the art to practice the aspects herein. Accordingly, the examples should not be construed as limiting the scope of the aspects herein.

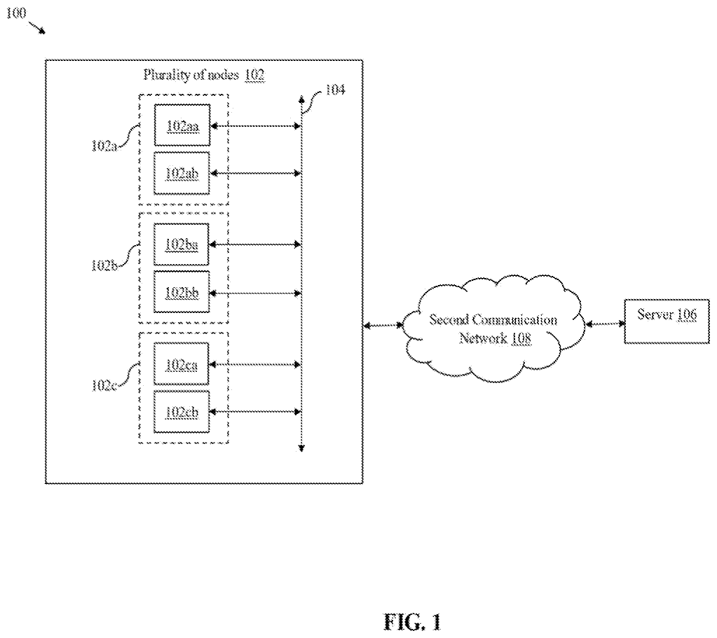

FIG. 1 illustrates a block diagram of a system 100 for globally distributed firewall protection, in accordance with an exemplary aspect of the present disclosure. The system 100 for globally distributed firewall protection (hereinafter interchangeably referred to as “the system 100”) may be configured to detect, prevent and/or mitigate the security threats and/or the cyber-attacks on each node of the distributed blockchain network. The system 100 may further be configured to monitor one or more attack patterns and/or malicious data on each node of the distributed blockchain network, and determine a way to mitigate the cyber-attacks in real time.

The system 100 may include a plurality of nodes 102 such that each node of the plurality of nodes 102 is communicatively coupled to each of the other nodes of the plurality of nodes 102 by way of a first communication network 104. In some aspects of the present disclosure, each node of the plurality of nodes 102 may be configured to operate cooperatively as a distributed network by sharing computation and storage resources by way of the first communication network 104. The system 100 may further include a server 106 communicatively coupled to the plurality of nodes 102 by way of a second communication network 108. In some aspects of the present disclosure, the first communication network 104 and the second communication network 108 may be a part of a single communication network (not shown), such that each node of the plurality of nodes 102 may be communicatively coupled to each other node of the plurality of nodes 102 and the server 106 by way of the single communication network.

In some aspects of the present disclosure, each node of the plurality of nodes 102 may be configured to share node information each of the other node of the plurality of nodes 102 to each other node of the plurality of nodes, such that each node of the plurality of nodes 102 may have node information of each of the other node of the plurality of nodes 102. The node information associated with each node of the plurality of nodes 102 may include but is not limited to, traffic data, a category of service, a computation capability, a storage capability, and the like of each node of the plurality of nodes 102.

In some aspects of the present disclosure, each node of the plurality of nodes 102 may be configured to share traffic data, a category of service, a computation capability, and a storage capability with each other node of the plurality of nodes. In some aspects of the present disclosure, the plurality of nodes 102 may be configured to segregate the plurality of nodes 102 into a first set of nodes 102a, a second set of nodes 102b, and a third set of nodes 102c. The first set of nodes 102a may be segregated based on the traffic data and the category of service of each node of the plurality of nodes 102. The second set of nodes 102b and the third set of nodes 102c may be segregated based on the traffic data, the category of service, the computation capability, and the storage capability, of each node of the plurality of nodes 102, using one or more artificial intelligence techniques.

In some aspects of the present disclosure, the plurality of nodes 102 may be configured to detect a cyber-attack on each node of the first set of nodes 102a. To detect the cyber-attack on each node of the first set of nodes 102a, the plurality of nodes 102 may be configured to compare the traffic data of each node of the plurality of nodes 102 with pre-defined traffic data corresponding to the category of service of each node of the plurality of nodes 102.

In some aspects of the present disclosure, the second set of nodes 102b may be configured to detect a type of attack on each node of the first set of nodes 102a. In some aspects of the present disclosure, the second set of nodes 102b may be configured to determine the type of attack on each node of the first set of nodes 102a based on the traffic data and the category of service of each node of the first set of nodes 102a. In some aspects of the present disclosure, the second set of nodes 102b may be configured to use one or more artificial intelligence (AI) techniques to detect the type of attack on each node of the first set of nodes 102a.

The second set of nodes 102b may further be configured to generate a set of attack patterns for the first set of nodes 102b. In some aspects of the present disclosure, the second set of nodes 102b may be configured to generate an attack pattern for each node of the first set of nodes 102a such that the set of attack patterns may include the attack pattern of each node of the first set of nodes 102a. In some aspects of the present disclosure, the second set of nodes 102b may be configured to generate the set of attack patterns by analyzing the traffic data of each node of the first set of nodes 102a for a pre-defined interval of time.

Furthermore, the second set of nodes 102b may be configured to select one or more attack patterns from the generated set of attack patterns having a matching score value higher than a pre-defined threshold value. In some aspects of the present disclosure, to select the one or more attack patterns, the second set of nodes 102b may be configured to compare each of the generated attack pattern of the set of attack patterns with a set of pre-defined attack patterns. In some aspects of the present disclosure, the set of pre-defined attack patterns may be associated with the category of service and the type of attack on each node of the first set of nodes 102a. The second set of nodes 102b may further be configured to generate a matching score value for each attack pattern for the set of attack patterns. In some aspects of the present disclosure, the second set of nodes 102b may be configured to generate the matching score value by matching the attack pattern of each node of the first set of nodes 102a with the set of pre-defined attack patterns corresponding to the type of attack of each node of the first set of nodes 102a.

Furthermore, the second set of nodes 102b may be configured to generate a first set of protocols for the selected one or more attack patterns having the matching score value higher than the pre-defined threshold value. In some aspects of the present disclosure, the second set of nodes 102b may be configured to fetch a set of protocols associated with the one or more selected attack patterns having the matching score value higher than the pre-defined threshold value. The second set of nodes 102b may further be configured to use the fetched set of protocols to generate the first set of protocols for the selected one or more attack patterns. In some aspects of the present disclosure, the second set of nodes 102b may be configured to generate the first set of protocols using one or more artificial intelligence (AI) techniques.

Furthermore, the second set of nodes 102b may be configured to generate a second set of protocols for one or more attack patterns having the first score lower than the pre-defined threshold value. In some aspects of the present disclosure, the second set of nodes 102b may be configured to generate the second set of protocols using one or more artificial intelligence (AI) techniques. In some aspects of the present disclosure, the second set of nodes 102b may be configured to send the first set of protocols and the second set of protocols to the third set of nodes 102c for validation.

Furthermore, the second set of nodes 102b may be configured to receive a set of valid protocols from the third set of nodes. In some aspects of the present disclosure, the second set of nodes 102b may be configured to configured to mitigate the cyber-attack on one or more node of the first set of nodes 102a using the set of valid protocols.

The third set of nodes 102c may be configured to receive the first set of protocols and the second set of protocols from the second set of nodes 102b. The third set of nodes 102c may further be configured to check a validity of each protocol of the first set of protocols and a validity of each protocol of the second set of protocols. The third set of nodes 102c may further be configured to generate the set of valid protocols based on the validity of the validity of the first set of nodes and the second set of nodes. In some aspects of the present disclosure, the set of valid protocols may include one or more valid protocols from the first set of nodes and one or more valid protocols from the second set of protocols. The third set of nodes 102c may further be configured to distribute the set of valid protocols to the plurality of nodes 102.

The plurality of nodes 102 (in FIG. 1) are shown to include two nodes in the first set of nodes 102a (i.e., first and second of which are shown as 102aa and 102ab, respectively), two nodes in the second set of nodes 102b (i.e., first and second of which are shown as 102ba and 102bb, respectively) and two nodes in the third set of nodes 102c (i.e., first and second of which are shown as 102ca and 102cb, respectively) to make the illustrations concise and clear. However, it will be apparent to a person skilled in the art that the first through third set of nodes 102a-102c may include any number of nodes and thus the number of nodes in the first through third set of nodes 102a-102c should not be considered as a limitation of the present disclosure. Further, it will be apparent to a person skilled in the art that each node of the first through third set of nodes 102a-102c is configured to serve one or more functionalities in a manner similar to the functionalities being served by the first node 102aa, first node 102ba and first node 102ca of the first through third set of nodes 102a-102c, respectively.

In some aspects of the present disclosure, the server 106 may be a network of computers, a software framework, or a combination thereof, that may provide a generalized approach to create the server implementation. Examples of the server 106 may include, but are not limited to, personal computers, laptops, mini-computers, mainframe computers, any non-transient and tangible machine that can execute a machine-readable code, cloud-based servers, distributed server networks, or a network of computer systems. The server 106 may be realized through various web-based technologies such as, but not limited to, a Java web-framework, a .NET framework, a personal home page (PHP) framework, or any web-application framework. Aspects of the present disclosure are intended to include and/or otherwise cover any type of the server 106 including known, related and later developed technologies.

In some aspects of the present disclosure, the server 106 may be communicatively coupled with each node of the plurality of nodes 102 and may be accessed by each node of the plurality of nodes 102 by way of a device console not shown corresponding to each node of the plurality of nodes 102. In some aspects of the present disclosure, the server 106 may be configured to receive data from the plurality of nodes 102 at a regular interval of time. In other aspects of the present disclosure, the server 106 may be configured to receive data from each node of the plurality of nodes 102 as and when decided by each node of the plurality of nodes 102. In some aspects of the present disclosure, the server 106 may be configured to store a copy of the data corresponding to each node of the plurality of nodes 102 as a backup. In some aspects of the present disclosure, the server 106 may be configured to receive data from each node of the plurality of nodes 102 with a timestamp (hereinafter interchangeably referred to as “a transition” between each node of the plurality of nodes 102 and the server 106). Further, the server 106 may include a look-up table, such that the server 106 may provide metadata corresponding to each transition between each nodes of the plurality of nodes 102 and the server 106 by way of the look-up table.

In other aspects of the present disclosure, a set of centralized or distributed network of peripheral memory devices may be interfaced with the server 106, as an example, on a cloud server. It will be apparent to a person having ordinary skill in the art that the server 106 is for illustrative purposes and not limited to any specific combination of hardware circuitry and/or software.

In some aspects of the present disclosure, a data center and/or a stand-alone device may act as one or more nodes of the plurality of nodes 102, such that the data center may include one or more user devices, and the stand-alone device may act as the user device.

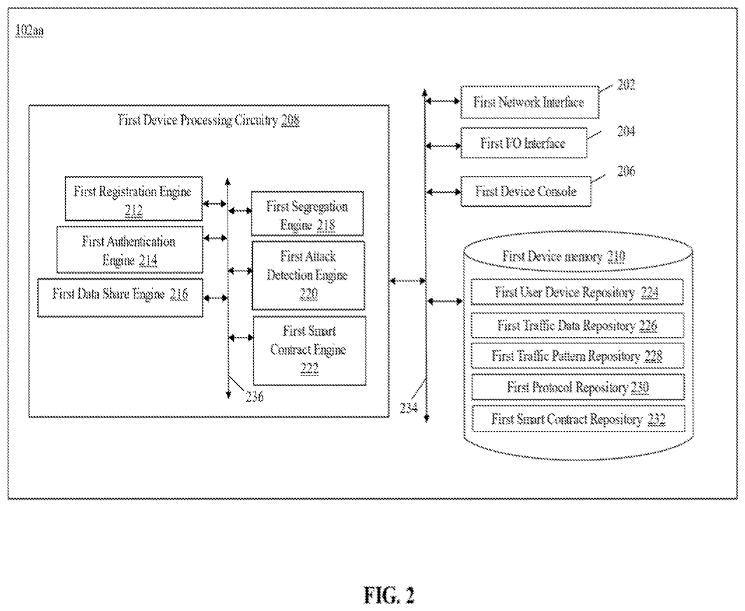

FIG. 2 illustrates a block diagram of the first node 102aa of the first set of nodes 102a of the system 100, in accordance with an exemplary aspect of the present disclosure. The first node 102aa (hereinafter interchangeably referred to and designated as “the first user device 102aa) may include a first network interface 202, a first input-output (I/O) interface 204, a first device console 206, a first device processing circuitry 208 and a first device memory 210 communicatively coupled to each other by way of a first communication bus 234.

In some aspects of the present disclosure, the first network interface 202 may be configured to enable communication between the first user device 102aa with each node of the plurality of nodes 102. In some aspects of the present disclosure, the first network interface 202 may be implemented by use of various known technologies to support wired or wireless communication between the first user device 102aa and each node of the plurality of nodes 102 by way of the first communication network 104. The first network interface 202 may further be implemented by use of various known technologies to support wired or wireless communication between the first user device 102aa and the server 106 by way of the second communication network 108. The first network interface 202 may include, but is not limited to, an Ethernet card, a communication port, and/or a Personal Computer Memory Card International Association (PCMCIA) slot and card, an antenna, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. Aspects of the present disclosure are intended to include and/or otherwise cover any type of the first network interface 202 including known, related and later developed technologies. It will be apparent to a person of ordinary skill in the art that the first network interface 202 may include any device and/or apparatus capable of providing wireless or wired communications between the first user device 102aa and each node of the plurality of nodes 102, and the first user device 102aa with the server 106.

In some aspects of the present disclosure, the first I/O interface 204 may include suitable logic, circuitry, interfaces, and/or code configured to receive inputs and transmit outputs via a plurality of data ports in the first user device 102aa. The first I/O interface 204 may include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker. Aspects of the present disclosure are intended to include and/or otherwise cover any type of the first I/O interface 204 including known, related and later developed technologies.

In some aspects of the present disclosure, the first device console 206 may be configured as a computer-executable application, to be executed by the first device processing circuitry 208. In some aspects of the present disclosure, the first device console 206 may include suitable logic, instructions, and/or codes for executing various operations of the first user device 102aa. The one or more computer executable applications may be stored in the first device memory 210. Examples of the one or more computer executable applications may include, but are not limited to, an audio application, a video application, a social media application, a navigation application, or the like. Aspects of the present disclosure are intended to include and/or otherwise cover any type of the first device console 206 including known, related and later developed technologies.

In some aspects of the present disclosure, the first device processing circuitry (DPC) 208 may include a first registration engine 212, a first authentication engine 214, a first data share engine 216, a first segregation engine 218, a first attack detection engine 220, and a first smart contract engine 222 communicatively coupled by way of a second communication bus 236.

In some aspects of the present disclosure, the first registration engine 212 may be configured to enable the first user device 102aa to register on the system 100 for joining the plurality of nodes 102. The first authentication engine 214 may be configured to authenticate and/or validate the first user device 102aa for joining the plurality of nodes 102.

In some aspects of the present disclosure, the system 100 by way of the first registration engine 212 and the first authentication engine 214 may enable a deployment of a new consumer node (i.e., through the first user device 102aa) to the plurality of nodes 102 of the system 100, and thus may facilitate the new consumer node with a public distributed network. In some aspects of the present disclosure, upon successful authentication of the new consumer node, the system 100 may facilitate the new consumer node to utilize one or more storage and computation resources of the plurality of nodes 102.

The first data share engine 216 may be configured to enable the first user device 102aa to share node information that includes traffic data, a category of service, a computation capability, and a storage capability of the first user device 102aa to each node of the plurality of nodes 102. The first data share engine 216 may further be configured to receive the traffic data, the category of service, the computation capability, and the storage capability from one or more nodes of the plurality of nodes 102. Furthermore, the first data share engine 216 may further be configured to receive the set of valid protocols from the third set of nodes 102c.

The first segregation engine 218, based on a comparison of the received traffic data, the category of service, the computation capability, and the storage capability with a pre-defined resource data, may be configured to segregate the plurality of nodes 102 into the first set of nodes 102a, the second set of nodes 102b and the third set of nodes 102c. In some aspects of the present disclosure, the first segregation engine 218 may be configured to segregate the plurality of nodes 102 into the first through third sets of nodes 102a-102c using one or more AI techniques.

The first attack detection engine 220 may be configured to detect the cyber-attack on each node of the first set of nodes 102a. To detect the cyber-attack on each node of the first set of nodes 102a, the first attack detection engine 222 may be configured to compare the traffic data of each node of the plurality of nodes 102 with pre-defined traffic data corresponding to the category of service of each node of the plurality of nodes 102. In some aspects of the present disclosure, the first attack detection engine 220 may be configured to detect the cyber-attack on each node of the first set of nodes 102a using one or more AI techniques.

The first smart contract engine 222 may be configured to generate one or more smart contracts for the plurality of nodes 102 to enable the co-operative operation between each node of the plurality of nodes 102.

In some aspects of the present disclosure, the first device memory 210 may include a first user device repository 224, a first traffic data repository 226, a first attack pattern repository 228, a first protocol repository 230 and a first smart contract repository 232. Examples of the first device memory 210 may include but are not limited to, a ROM, a RAM, a flash memory, a removable storage drive, a HDD, a solid-state memory, a magnetic storage drive, a PROM, an EPROM, and/or an EEPROM. Aspects of the present disclosure are intended to include and/or otherwise cover any type of the first device memory 210 including known, related and later developed technologies.

The first user device repository 224 may be configured to store metadata of the first user device 102aa. The first traffic data repository 226 may be configured to store traffic data of each node of the plurality of nodes 102 of the system 100. The first traffic pattern repository 228 may be configured to store a traffic pattern data of each node of the plurality of nodes 102 of the system 100. The first protocol repository 230 may be configured to store the set of valid protocols of the system 100. The first smart contract repository 232 may be configured to store one or more smart contracts between the plurality of nodes 102 for co-operative operation of the plurality of nodes 102 of the system 100.

In some aspects of the present disclosure, the first user device 102aa may be configured as a virtual machine configured to co-operatively operate in a distributed manner, by sharing computational and storage resources with the plurality of nodes 102. It must be apparent to a person skilled in the art that the virtual machine may be a hardware, that is configured to perform one or more of computation and/or storage tasks.

In some aspects of the present disclosure, a data center may act as the first node 102aa of the first set of nodes 102a, such that the data center may include one or more user devices. It will be apparent to a person skilled in the art that the data center may include any number of user devices without deviating from the scope of the present disclosure. In such scenario, each user device of the data center is configured to serve one or more functionalities in a manner similar to the functionalities being served by the first user device 102aa of the first set of nodes 102a as described hereinabove.

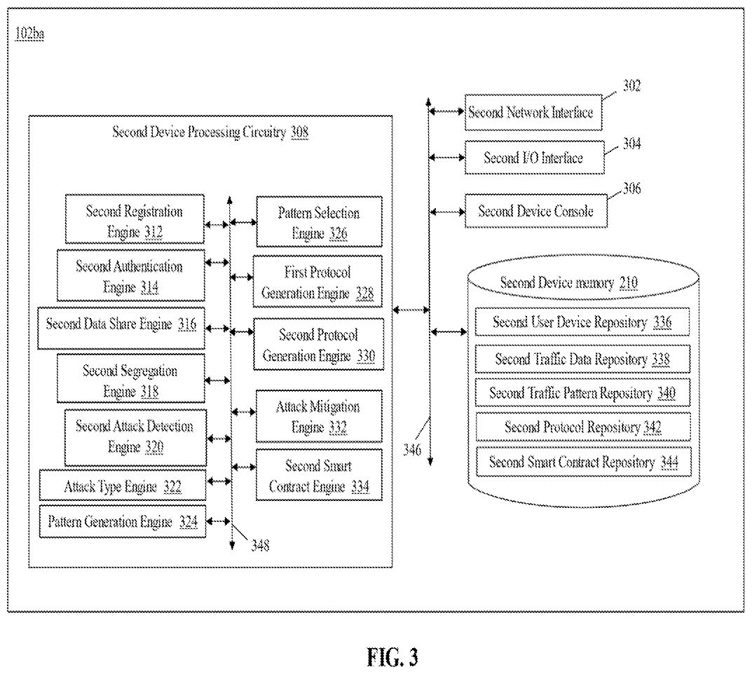

FIG. 3 illustrates a block diagram of the first node 102ba of the second set of nodes 102b of the system 100, in accordance with an exemplary aspect of the present disclosure. The first node 102ba (hereinafter interchangeably referred to and designated as “the second user device 102ba) may include a second network interface 302, a second input-output (I/O) interface 304, a second device console 306, a second device processing circuitry 308 and a second device memory 310 communicatively coupled to each other by way of a third communication bus 348.

In some aspects of the present disclosure, the second network interface 302 may be configured to enable communication between the second user device 102ba with each node of the plurality of nodes 102. In some aspects of the present disclosure, the second network interface 302 may be implemented by use of various known technologies to support wired or wireless communication between the second user device 102ba and each node of the plurality of nodes 102 by way of the first communication network 104. The second network interface 302 may further be implemented by use of various known technologies to support wired or wireless communication between the second user device 102ba and the server 106 by way of the second communication network 108. The second network interface 302 may include, but is not limited to, an Ethernet card, a communication port, and/or a Personal Computer Memory Card International Association (PCMCIA) slot and card, an antenna, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. Aspects of the present disclosure are intended to include and/or otherwise cover any type of the second network interface 302 including known, related and later developed technologies. It will be apparent to a person of ordinary skill in the art that the second network interface 302 may include any device and/or apparatus capable of providing wireless or wired communications between the second user device 102ba and each node of the plurality of nodes 102, and the second user device 102ba with the server 106.

In some aspects of the present disclosure, the second I/O interface 304 may include suitable logic, circuitry, interfaces, and/or code configured to receive inputs and transmit outputs via a plurality of data ports in the second user device 102ba. The second I/O interface 304 may include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker. Aspects of the present disclosure are intended to include and/or otherwise cover any type of the second I/O interface 304 including known, related and later developed technologies.

In some aspects of the present disclosure, the second device console 306 may be configured as a computer-executable application, to be executed by the second device processing circuitry 308. In some aspects of the present disclosure, the second device console 306 may include suitable logic, instructions, and/or codes for executing various operations of the second user device 102ba. The one or more computer executable applications may be stored in the second device memory 310. Examples of the one or more computer executable applications may include, but are not limited to, an audio application, a video application, a social media application, a navigation application, or the like. Aspects of the present disclosure are intended to include and/or otherwise cover any type of the second device console 306 including known, related and later developed technologies.

In some aspects of the present disclosure, the second device processing circuitry (DPC) 308 may include a second registration engine 312, a second authentication engine 314, a second data share engine 316, a second segregation engine 318, a second attack detection engine 320, an attack type engine 322, a pattern generation engine 324, a pattern selection engine 326, a first protocol engine 328, a second protocol engine 330, an attack mitigation engine 332, and a second smart contract engine 334 communicatively coupled by way of a fourth communication bus 348.

In some aspects of the present disclosure, the second registration engine 312 may be configured to enable the second user device 102ba to register on the system 100 for joining the plurality of nodes 102. The second authentication engine 314 may be configured to authenticate and/or validate the second user device 102ba for joining the plurality of nodes 102.

In some aspects of the present disclosure, the system 100 by way of the second registration engine 312 and the second authentication engine 314 may enable a deployment of a new processor node (i.e., through the second user device 102ba) to the plurality of nodes 102 of the system 100, and thus may facilitate the new processor node with a public distributed network. In some aspects of the present disclosure, upon successful authentication of the new processor node, the system 100 may facilitate the new processor node to utilize one or more storage and computation resources of the plurality of nodes 102.

The second data share engine 316 may be configured to enable the second user device 102ba to share node information that includes traffic data, a category of service, a computation capability, and a storage capability of the second user device 102ba to each node of the plurality of nodes 102. The second data share engine 316 may further be configured to receive the traffic data, the category of service, the computation capability, and the storage capability from one or more nodes of the plurality of nodes 102. Furthermore, the second data share engine 316 may further be configured to send the first set of protocols and the second set of protocols to the third set of nodes 102c. Furthermore, the second data share engine 316 may further be configured to receive the set of valid protocols from the third set of nodes 102c. The second segregation engine 318, based on a comparison of the received traffic data, the category of service, the computation capability, and the storage capability with the pre-defined resource data, may be configured to segregate the plurality of nodes 102 into the first set of nodes 102a, the second set of nodes 102b and the third set of nodes 102c. In some aspects of the present disclosure, the second segregation engine 318 may be configured to segregate the plurality of nodes 102 into the first through third sets of nodes 102a-102c using one or more AI techniques.

The second attack detection engine 320 may be configured to detect the cyber-attack on each node of the first set of nodes 102a. To detect the cyber-attack on each node of the first set of nodes 102a, the second attack detection engine 320 may be configured to compare the traffic data of each node of the plurality of nodes 102 with the pre-defined traffic data corresponding to the category of service of each node of the plurality of nodes 102. In some aspects of the present disclosure, the second attack detection engine 320 may be configured to detect the cyber-attack on each node of the first set of nodes 102a using one or more AI techniques.

The attack type engine 322 may be configured to detect the type of attack on each node of the first set of nodes 102a. In some aspects of the present disclosure, the attack engine 322 may be configured to determine the type of attack on each node of the first set of nodes 102a based on the traffic data and the category of service of each node of the first set of nodes 102a. In some aspects of the present disclosure, the attack engine 322 may be configured to use one or more artificial intelligence (AI) techniques to detect the type of attack on each node of the first set of nodes 102a.

The pattern generation engine 324 may be configured to generate the set of attack patterns for the first set of nodes 102b. In some aspects of the present disclosure, the pattern generation engine 324 may be configured to generate the attack pattern for each node of the first set of nodes 102a such that the set of attack patterns may include the attack pattern of each node of the first set of nodes 102a. In some aspects of the present disclosure, the pattern generation engine 324 may be configured to generate the set of attack patterns by analyzing the traffic data of each node of the first set of nodes 102a for the pre-defined interval of time.

The pattern selection engine 326 may be configured to select the one or more attack patterns from the generated set of attack patterns having the matching score value higher than the pre-defined threshold value. In some aspects of the present disclosure, to select the one or more attack patterns, the pattern selection engine 326 may be configured to compare each of the generated attack pattern of the set of attack patterns with the set of pre-defined attack patterns. In some aspects of the present disclosure, the set of pre-defined attack patterns may be associated with the category of service and the type of attack on each node of the first set of nodes 102a. The pattern selection engine 326 may further be configured to generate the matching score value for each attack pattern for the set of attack patterns. In some aspects of the present disclosure, the pattern selection engine 326 may be configured to generate the matching score value by matching the attack pattern of each node of the first set of nodes 102a with the set of pre-defined attack patterns corresponding to the type of attack of each node of the first set of nodes 102a.

The first protocol generation engine 328 may be configured to generate the first set of protocols for the one or more attack patterns having the matching score value higher than the pre-defined threshold value. In some aspects of the present disclosure, the first protocol generation engine 328 may be configured to fetch the set of protocols associated with the one or more selected attack patterns having the matching score value higher than the pre-defined threshold value. The first protocol generation engine 328 may further be configured to use the fetched set of protocols to generate the first set of protocols for the selected one or more attack patterns. In some aspects of the present disclosure, the first protocol generation engine 328 may be configured to generate the first set of protocols using one or more artificial intelligence (AI) techniques. In some aspects of the present disclosure, the first protocol generation engine 328 may be configured to send the first set of protocols to the third set of nodes 102c for validation.

The second protocol generation engine 330 may be configured to generate the second set of protocols for the one or more attack patterns having the matching score value lower than the pre-defined threshold value. In some aspects of the present disclosure, the second protocol generation engine 330 may be configured to generate the second set of protocols using one or more artificial intelligence (AI) techniques. In some aspects of the present disclosure, the second protocol generation engine 330 may be configured to send the second set of protocols to the third set of nodes 102c for validation.

The attack mitigation engine 332 may be configured to mitigate the cyber-attack on one or more node of the first set of nodes 102a using the set of valid protocols. The second smart contract engine 334 may be configured to generate one or more smart contracts for the plurality of nodes 102 to enable the co-operative operation between each node of the plurality of nodes 102.

In some aspects of the present disclosure, the second device memory 310 may include a second user device repository 336, a second traffic data repository 338, a second attack pattern repository 340, a second protocol repository 342, and a second smart contract repository 344. Examples of the first device memory 210 may include but are not limited to, a ROM, a RAM, a flash memory, a removable storage drive, a HDD, a solid-state memory, a magnetic storage drive, a PROM, an EPROM, and/or an EEPROM. Aspects of the present disclosure are intended to include and/or otherwise cover any type of the second device memory 310 including known, related and later developed technologies.

The second user device repository 336 may be configured to store metadata of the second user device 102ba. The second traffic data repository 338 may be configured to store traffic data of each node of the plurality of nodes 102 of the system 100. The second traffic pattern repository 340 may be configured to store a traffic pattern data of each node of the plurality of nodes 102 of the system 100. The second protocol repository 342 may be configured to store the set of valid protocols of the system 100. The second protocol repository 342 may further be configured to store the first set of protocols, and the second set of protocols. The second smart contract repository 344 may be configured to store one or more smart contracts between the plurality of nodes 102 for co-operative operation of the plurality of nodes 102 of the system 100.

In some aspects of the present disclosure, the second user device 102ba may be configured as a virtual machine configured to co-operatively operate in a distributed manner, by sharing computational and storage resources with the plurality of nodes 102. It must be apparent to a person skilled in the art that the virtual machine may be a hardware, that is configured to perform one or more of computation and/or storage tasks.

In some aspects of the present disclosure, a data center may act as the first node 102ba of the second set of nodes 102b, such that the data center may include one or more user devices. It will be apparent to a person skilled in the art that the data center may include any number of user devices without deviating from the scope of the present disclosure. In such scenario, each user device of the data center is configured to serve one or more functionalities in a manner similar to the functionalities being served by the second user device 102ba as described hereinabove.

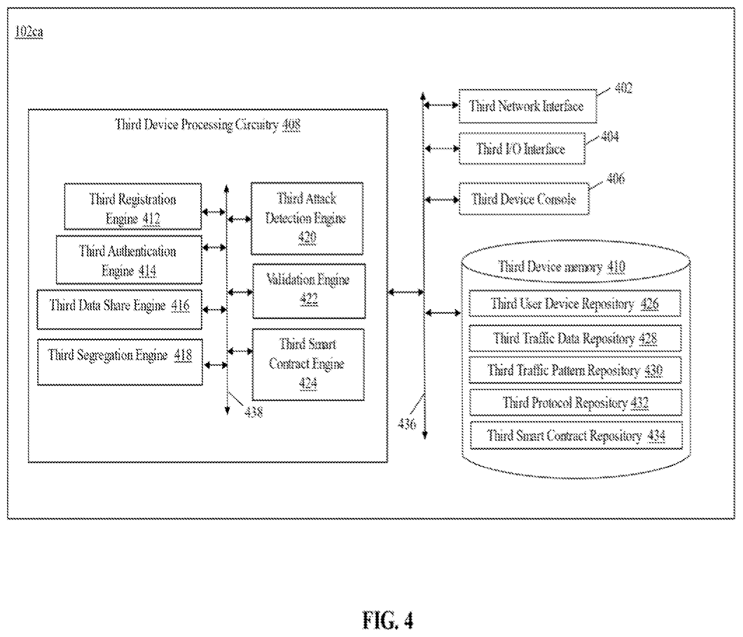

FIG. 4 illustrates a block diagram of the first node 102ca of the third set of nodes 102c of the system 100, in accordance with an exemplary aspect of the present disclosure. The first node 102ca (hereinafter interchangeably referred to and designated as “the third user device 102ca) may include a third network interface 402, a third input-output (I/O) interface 404, a third device console 406, a third device processing circuitry 408, and a third device memory 410 communicatively coupled to each other by way of a fifth communication bus 436.

In some aspects of the present disclosure, the third network interface 402 may be configured to enable communication between the third user device 102ca with each node of the plurality of nodes 102. In some aspects of the present disclosure, the third network interface 402 may be implemented by use of various known technologies to support wired or wireless communication between the third user device 102ca and each node of the plurality of nodes 102 by way of the first communication network 104. The third network interface 402 may further be implemented by use of various known technologies to support wired or wireless communication between the third user device 102ca and the server 106 by way of the second communication network 108. The third network interface 402 may include, but is not limited to, an Ethernet card, a communication port, and/or a Personal Computer Memory Card International Association (PCMCIA) slot and card, an antenna, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. Aspects of the present disclosure are intended to include and/or otherwise cover any type of the third network interface 402 including known, related and later developed technologies. It will be apparent to a person of ordinary skill in the art that the third network interface 402 may include any device and/or apparatus capable of providing wireless or wired communications between the third user device 102ca and each node of the plurality of nodes 102, and the third user device 102ca with the server 106.

In some aspects of the present disclosure, the third I/O interface 404 may include suitable logic, circuitry, interfaces, and/or code configured to receive inputs and transmit outputs via a plurality of data ports in the third user device 102ca. The third I/O interface 404 may include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker. Aspects of the present disclosure are intended to include and/or otherwise cover any type of the third I/O interface 404 including known, related and later developed technologies.

In some aspects of the present disclosure, the third device console 406 may be configured as a computer-executable application, to be executed by the third device processing circuitry 408. In some aspects of the present disclosure, the third device console 406 may include suitable logic, instructions, and/or codes for executing various operations of the third user device 102ca. The one or more computer executable applications may be stored in the third device memory 410. Examples of the one or more computer executable applications may include, but are not limited to, an audio application, a video application, a social media application, a navigation application, or the like. Aspects of the present disclosure are intended to include and/or otherwise cover any type of the third device console 406 including known, related and later developed technologies.

In some aspects of the present disclosure, the third device processing circuitry (DPC) 408 may include a third registration engine 412, a third authentication engine 414, a third data share engine 416, a third segregation engine 418, a third attack detection engine 420, a validation engine 422, and a third smart contract engine 424 communicatively coupled by way of a sixth communication bus 438.

In some aspects of the present disclosure, the third registration engine 412 may be configured to enable the third user device 102ca to register on the system 100 for joining the plurality of nodes 102. The third authentication engine 414 may be configured to authenticate and/or validate the third user device 102ca for joining the plurality of nodes 102.

In some aspects of the present disclosure, the system 100 by way of the third registration engine 412 and the third authentication engine 414 may enable a deployment of a new validator node (i.e., through the third user device 102ca) to the plurality of nodes 102 of the system 100, and thus may facilitate the new validator node with a public distributed network. In some aspects of the present disclosure, upon successful authentication of the new validator node, the system 100 may facilitate the new processor node to utilize one or more storage and computation resources of the plurality of nodes 102.

The third data share engine 416 may be configured to enable the third user device 102ca to share node information that includes traffic data, a category of service, a computation capability, and a storage capability of the third user device 102ca to each node of the plurality of nodes 102. The third data share engine 416 may further be configured to receive the traffic data, the category of service, the computation capability, and the storage capability from one or more nodes of the plurality of nodes 102. Furthermore, the third data share engine 416 may further be configured to send the set of valid protocols to each node of the plurality of nodes 102.

The third segregation engine 418, based on a comparison of the received traffic data, the category of service, the computation capability, and the storage capability with the pre-defined resource data, may be configured to segregate the plurality of nodes 102 into the first set of nodes 102a, the second set of nodes 102b and the third set of nodes 102c. In some aspects of the present disclosure, the third segregation engine 418 may be configured to segregate the plurality of nodes 102 into the first through third sets of nodes 102a-102c using one or more AI techniques.

The third attack detection engine 420 may be configured to detect the cyber-attack on each node of the first set of nodes 102a. To detect the cyber-attack on each node of the first set of nodes 102a, the s third attack detection engine 320 may be configured to compare the traffic data of each node of the plurality of nodes 102 with the pre-defined traffic data corresponding to the category of service of each node of the plurality of nodes 102. In some aspects of the present disclosure, the third attack detection engine 320 may be configured to detect the cyber-attack on each node of the first set of nodes 102a using one or more AI techniques.

The validation engine 422 may be configured to check the validity of each protocol of the first set of protocols and the validity of each protocol of the second set of protocols. The validation engine 422 may further be configured to generate the set of valid protocols based on the validity of the first set of nodes and the second set of nodes. In some aspects of the present disclosure, the set of valid protocols may include the one or more valid protocols from the first set of nodes and the one or more valid protocols from the second set of protocols. The validation engine 422 may further be configured to distribute the set of valid protocols to each node of the plurality of nodes 102.

The third smart contract engine 424 may be configured to generate one or more smart contracts for the plurality of nodes 102 to enable the co-operative operation between each node of the plurality of nodes 102.

In some aspects of the present disclosure, the third device memory 410 may include a third user device repository 426, a third traffic data repository 428, a third attack pattern repository 430, a third protocol repository 432, and a third smart contract repository 434. Examples of the third device memory 310 may include but are not limited to, a ROM, a RAM, a flash memory, a removable storage drive, a HDD, a solid-state memory, a magnetic storage drive, a PROM, an EPROM, and/or an EEPROM. Aspects of the present disclosure are intended to include and/or otherwise cover any type of the third device memory 410 including known, related and later developed technologies.

The third user device repository 426 may be configured to store metadata of the third user device 102ca. The third traffic data repository 428 may be configured to store traffic data of each node of the plurality of nodes 102 of the system 100. The third traffic pattern repository 430 may be configured to store a traffic pattern data of each node of the plurality of nodes 102 of the system 100. The third protocol repository 432 may be configured to store the set of valid protocols of the system 100. The third protocol repository 432 may further be configured to store the first set of protocols, and the second set of protocols. The third smart contract repository 434 may be configured to store one or more smart contracts between the plurality of nodes 102 for co-operative operation of the plurality of nodes 102 of the system 100.

In some aspects of the present disclosure, the third user device 102ca may be configured as a virtual machine configured to co-operatively operate in a distributed manner, by sharing computational and storage resources with the plurality of nodes 102. It must be apparent to a person skilled in the art that the virtual machine may be a hardware, that is configured to perform one or more of computation and/or storage tasks.

In some aspects of the present disclosure, a data center may act as the first node 102ca of the third set of nodes 102c, such that the data center may include one or more user devices. It will be apparent to a person skilled in the art that the data center may include any number of user devices without deviating from the scope of the present disclosure. In such scenario, each user device of the data center is configured to serve one or more functionalities in a manner similar to the functionalities being served by the third user device 102ca as described hereinabove.

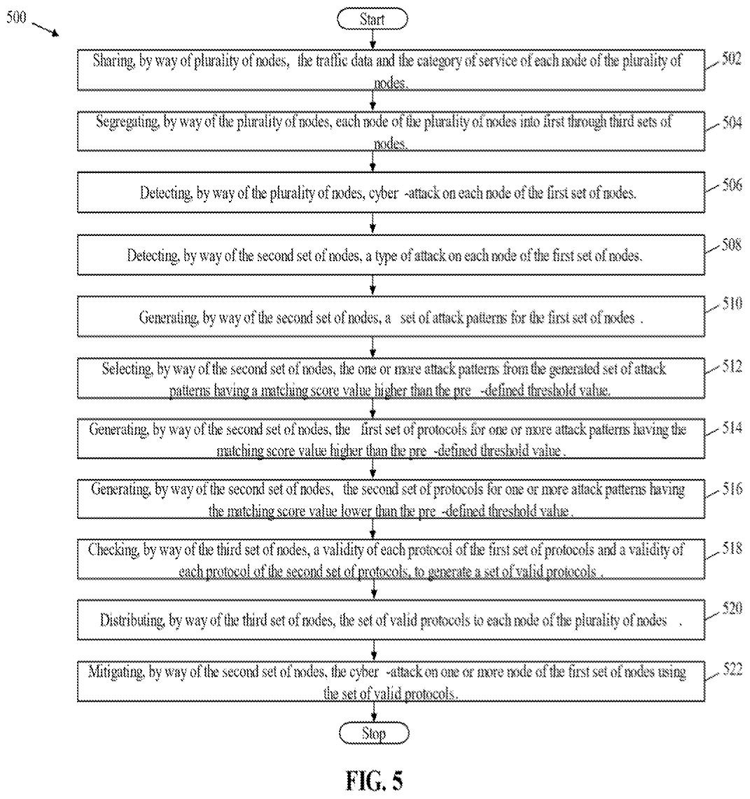

FIG. 5 illustrates a flow chart of a method 500 for globally distributed firewall protection, in accordance with an exemplary aspect of the present disclosure.

At step 502, the system, 100 by way of the plurality of nodes 102, may share the traffic data and the category of service of each node of the plurality of nodes 102.

At step 504, the system, 100 by way of the plurality of nodes 102, may segregate the plurality of nodes 102 into the first through third sets of nodes 102a-102c. In some aspects of the present disclosure, the system 100 may segregate the plurality of nodes 102 into the first through third sets of nodes 102a-102c using one or more AI techniques.

At step 506, the system 100, by way of the plurality of nodes 102, may detect the cyber-attack on each node of the first set of nodes 102a. In some aspects of the present disclosure, to detect the cyber-attack on each node of the first set of nodes 102a, the system 100 may compare the traffic data of each node of the plurality of nodes 102 with the pre-defined traffic data corresponding to the category of service of each node of the plurality of nodes 102. In some aspects of the present disclosure, the system 100 may detect the cyber-attack on each node of the first set of nodes 102a using one or more AI techniques.

At step 508, the system 100, by way of the second set of nodes 102b, may detect the type of attack on each node of the first set of nodes 102a. In some aspects of the present disclosure, the system 100 may determine the type of attack on each node of the first set of nodes 102a based on the traffic data and the category of service of each node of the first set of nodes 102a. In some aspects of the present disclosure, the system 100 may use one or more artificial intelligence (AI) techniques to detect the type of attack on each node of the first set of nodes 102a.

At step 510, the system 100, by way of the second set of nodes 102b, may generate the set of attack patterns for the first set of nodes 102b. In some aspects of the present disclosure, the system 100 may generate the attack pattern for each node of the first set of nodes 102a such that the set of attack patterns may include the attack pattern of each node of the first set of nodes 102a. In some aspects of the present disclosure, the system 100 may generate the set of attack patterns by analyzing the traffic data of each node of the first set of nodes 102a for the pre-defined interval of time.

At step 512, the system 100, by way of the second set of nodes 102b, may select the one or more attack patterns from the generated set of attack patterns having the matching score value higher than the pre-defined threshold value. In some aspects of the present disclosure, to select the one or more attack patterns, the pattern selection engine 326 may be configured to compare each of the generated attack pattern of the set of attack patterns with the set of pre-defined attack patterns. In some aspects of the present disclosure, the set of pre-defined attack patterns may be associated with the category of service and the type of attack on each node of the first set of nodes 102a. In some aspects of the present disclosure, the system 100 may generate the matching score value by matching the attack pattern of each node of the first set of nodes 102a with the set of pre-defined attack patterns corresponding to the type of attack of each node of the first set of nodes 102a.

At step 514, the system 100, by way of the second set of nodes 102b, may generate the first set of protocols for the one or more attack patterns having the matching score value higher than the pre-defined threshold value. In some aspects of the present disclosure, the system 100 may fetch the set of protocols associated with the one or more selected attack patterns having the matching score value higher than the pre-defined threshold value. The system 100 may further use the fetched set of protocols to generate the first set of protocols for the selected one or more attack patterns. In some aspects of the present disclosure, the system 100 may generate the first set of protocols using one or more artificial intelligence (AI) techniques. In some aspects of the present disclosure, the system 100 may send the first set of protocols to the third set of nodes 102c for validation.

At step 516, the system 100, by way of the second set of nodes 102b, may generate the second set of protocols for the one or more attack patterns having the matching score value lower than the pre-defined threshold value. In some aspects of the present disclosure, the system 100 may generate the second set of protocols using one or more artificial intelligence (AI) techniques. In some aspects of the present disclosure, the system 100 may send the second set of protocols to the third set of nodes 102c for validation.

At step 518, the system 100, by way of the third set of nodes 102c, may check the validity of each protocol of the first set of protocols and the validity of each protocol of the second set of protocols. The system 100 may further generate the set of valid protocols based on the validity of the first set of nodes and the second set of nodes. In some aspects of the present disclosure, the set of valid protocols may include the one or more valid protocols from the first set of nodes and the one or more valid protocols from the second set of protocols.

At step 520, the system 100, by way of the third set of nodes 102c, may further distribute the set of valid protocols to each node of the plurality of nodes 102.

At step 522, the system 100, by way of the second set of nodes 102b, may mitigate the cyber-attack on one or more node of the first set of nodes (102a) using the set of valid protocols.

The system 100 for globally distributed firewall protection may be configured to detect, prevent and/or mitigate the security threats and/or the cyber-attacks on each node of the distributed blockchain network. The system 100 may further be configured to monitor one or more attack patterns and/or malicious data on each node of the distributed blockchain network, and determine the way to mitigate the cyber-attacks in real time.

As will be readily apparent to those skilled in the art, aspects of the present disclosure may easily be produced in other specific forms without departing from their essential characteristics. Aspects of the present disclosure are, therefore, to be considered as merely illustrative and not restrictive, the scope being indicated by the claims rather than the foregoing description, and all changes which come within therefore intended to be embraced therein.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

We claims:

1. A system (100) comprising:
a plurality of nodes (102) comprising:
a first set of nodes (102a);
a second set of nodes (102b) configured to (i) detect a type of attack on each node of the first set of nodes (102a), (ii) generate a set of attack patterns for the first set of nodes (102b), (iii) select one or more attack patterns from the generated set of attack patterns having a matching score value higher than a pre-defined threshold value, (iv) generate a first set of protocols for the one or more attack patterns having the matching score value higher than the pre-defined threshold value, and (v) generate a second set of protocols for one or more attack patterns having the matching score value lower than the pre-defined threshold value; and
a third set of nodes (102c) configured to (i) check a validity of each protocol of the first set of protocols and a validity of each protocol of the second set of protocols, to generate a set of valid protocols, and (ii) distribute the set of valid protocols to each node of the plurality of nodes (102).

2. The system (100) as claimed in claim 1, wherein the plurality of nodes (102) are configured to segregate the plurality of nodes (102) into the first through third set of nodes (102a-102c), wherein (i) the first set of nodes (102a) are segregated based on traffic data and a category of service of each node of the plurality of nodes (102) and (ii) the second and third set of nodes (102b, 102c) are segregated based on the traffic data, the category of service, a computation capability, and a storage capability, of each node of the plurality of nodes (102), using one or more artificial intelligence techniques.

3. The system (100) as claimed in claim 1, wherein, prior to the segregation of the plurality of nodes (102), each node of the plurality of nodes (102) is configured to share traffic data, a category of service, a computation capability, and a storage capability with each other node of the plurality of nodes (102).

4. The system (100) as claimed in claim 1, wherein, prior to the detection of the type of attack on the on each node of the first set of nodes (102a), the plurality of nodes (102) are configured to detect a cyber-attack on each node of the first set of nodes (102a), wherein, to detect the cyber-attack on each node of the first set of nodes (102a), the plurality of nodes (102) are configured to compare the traffic data of each node of the plurality of nodes (102) with pre-defined traffic data corresponding to the category of service of each node of the plurality of nodes (102).

5. The system (100) as claimed in claim 1, wherein, prior to the selection of the one or more attack patterns from the generated set of attack patterns, the second set of nodes (102b) are configured to (i) compare each of the generated attack pattern of the set of attack patterns with a set of pre-defined attack patterns, and (ii) generate the matching score value for each attack pattern for the set of attack patterns.

6. The system (100) as claimed in claim 1, wherein, upon the distribution of the one or more valid protocols, the second set of nodes (102b) are configured to mitigate the cyber-attack on one or more node of the first set of nodes (102a) using the set of valid protocols.

7. A method (500) comprising:
detecting, by way of a second set of nodes (102b) of a plurality of nodes (102), a type of attack on each node of a first set of nodes (102a) of the plurality of nodes (102);
generating, by way of the second set of nodes (102b), a set of attack patterns for the first set of nodes (102b);
selecting, by way of the second set of nodes (102b), one or more attack patterns from the generated set of attack patterns having a matching score value higher than a pre-defined threshold value;
generating, by way of the second set of nodes (102b), a first set of protocols for the one or more attack patterns having the matching score value higher than the pre-defined threshold value;
generating, by way of the second set of nodes (102b), a second set of protocols for one or more attack patterns having the matching score value lower than the pre-defined threshold value;
checking, by way of a third set of nodes (102c) of the plurality of nodes (102), a validity of each protocol of the first set of protocols and a validity of each protocol of the second set of protocols, to generate a set of valid protocols; and
distributing, by way of the third set of nodes (102c), the set of valid protocols to each node of the plurality of nodes (102).

8. The method (500) as claimed in claim 7 further comprising segregating, by way of the plurality of nodes (102), the plurality of nodes (102) into the first through third set of nodes (102a-102c), wherein (i) the first set of nodes (102a) are segregated based on traffic data and a category of service of each node of the plurality of nodes (102) and (ii) the second and third set of nodes (102b, 102c) are segregated based on the traffic data, the category of service, a computation capability, and a storage capability, of each node of the plurality of nodes (102), using one or more artificial intelligence techniques.

9. The method (500) as claimed in claim 7, wherein, prior to the segregation of the plurality of nodes (102), the method (500) comprising sharing, by way of each node of the plurality of nodes (102), traffic data, a category of service, a computation capability, and a storage capability with each other node of the plurality of nodes (102).

10. The method (500) as claimed in claim 7, wherein, prior to the detection of the type of attack on the on each node of the first set of nodes (102a), the method (500) comprising detecting, by way of the plurality of nodes (102), a cyber-attack on each node of the first set of nodes (102a), wherein, for detecting the cyber-attack on each node of the first set of nodes (102a), the method (500) comprising comparing, by way of the plurality of nodes (102), the traffic data of each node of the plurality of nodes (102) with pre-defined traffic data corresponding to the category of service of each node of the plurality of nodes (102).

11. The method (500) as claimed in claim 7, wherein, prior to the selection of the one or more attack patterns from the generated set of attack patterns, the method (500) comprising (i) comparing, by way of the second set of nodes (102b), each of the generated attack pattern of the set of attack patterns with a set of pre-defined attack patterns, and (ii) generating, by way of the second set of nodes (102b), the matching score value for each attack pattern for the set of attack patterns.

12. The method (500) as claimed in claim 7, wherein, upon the distribution of the one or more valid protocols, the method (500) comprising mitigating, by way of the second set of nodes (102b), the cyber-attack on one or more node of the first set of nodes (102a) using the set of valid protocols.
